(19) United States
(12) Patent Application Publication
(10) Pub. No.: US 2013/0097821 A1
(43) Pub. Date: Apr. 25, 2013

(54) Auxiliary Gear Attachment System and Method

(71) Applicant: Velocity Systems, LLC, Dulles, VA (US)

(72) Inventor: David B. Strum, Amissville, VA (US)

(73) Assignee: Velocity Systems, LLC, Dulles, VA (US)

(21) Appl. No.: 13/655,538

(22) Filed: Oct. 19, 2012

Related U.S. Application Data
(60) Provisional application No. 61/548,979, filed on Oct. 19, 2011.

(51) Int. Cl. A44B 11/04; B23P 11/00; A44B 18/00

(52) U.S. Cl. 24/442; 24/265 AL; 29/428

(57) ABSTRACT

The present invention provides a quick attach/detach system that provides for minimal alteration to the aesthetics of the auxiliary equipment and the wearable personal device, which can be an armor carrier, backpack system or other outerwear, for example. The system can comprise, in one embodiment, a tongued attachment strap and a retention strip arrangement. One embodiment of the tongued attachment strap of the present invention comprises four individual components: a first strap portion, a second strap portion, a first stiffener and a second stiffener.

### CROSS-REFERENCE TO RELATED APPLICATIONS

The present application claims the benefit of U.S. Provisional Application Ser. No. 61/548,979, filed Oct. 19, 2011 and entitled, “Auxiliary Gear Attachment System and Method”, the disclosure of which is incorporated herein in its entirety.

### FIELD OF THE INVENTION

The present invention relates to outerwear, and more particularly to customizable outerwear that can adapt to accept auxiliary gear in various ways.

### BACKGROUND AND SUMMARY OF THE INVENTION

Military personnel, law enforcement personnel and/or outdoor enthusiasts all share a need to be able to quickly attach and detach peripheral equipment. For military personnel, the peripheral equipment can be, for example, a chest rig, ammunition pouch, medical bag, day pack, hydration pack or armor shield. Similarly, recreationists such as backpackers, campers, hikers, hunters and others may attach auxiliary gear such as a tent, food, climbing gear, first aid equipment or other gear, for example. Traditionally, pouches and equipment are attached to armor or recreational systems via clips, buckles, straps, snaps, etc. These attachment methods can be cumbersome and require the user to modify their routine or posture. The present invention permits the individual with a wearable personal device to add carrying capacity without compromising space requirements and while maintaining his or her sitting posture, rucksack inventory or uniform appearance, for example.

The present invention provides a quick attach/detach system that provides for minimal alteration to the aesthetics of the auxiliary equipment and the wearable personal device, which can be an armor carrier, backpack system or other outerwear, for example. The system of the present invention can be offered in varied sizes and shapes to accommodate not only dimensional requests, but capacity of auxiliary equipment. In one embodiment, the system of the present invention can be employed, for example, with a webbing system previously attached to the wearable personal device. The present invention can include, for example, a two piece system including a fixed attachment point and a tongued piece of webbing with a weighted attachment end and a weighted anchor end, thereby facilitating quick and simple attachment and detachment of the auxiliary equipment. In one embodiment, the present invention provides a two piece system including an attachment point consisting of two (2) layers of webbing where a “tongue” or third piece of webbing passes through the top and bottom webbing and then flips back and down 180° and under the bottom fixed webbing. A stiffener is utilized in both the anchor point and the tongue creating leverage and thus locking in the equipment.

### BRIEF DESCRIPTIONS OF THE DRAWINGS

FIG. 1 is a photograph of an auxiliary gear attachment system according to one embodiment of the present invention and in one stage of deployment into an article such as a personal wearable device.

FIGS. 2 through 5 are photographs of the attachment system of FIG. 1 in further stages of deployment.

FIG. 6 is a top plan schematic view of exemplary components used to manufacture one embodiment of a tongued attachment strap in accordance with the present invention.

### DESCRIPTION OF EMBODIMENTS OF THE PRESENT INVENTION

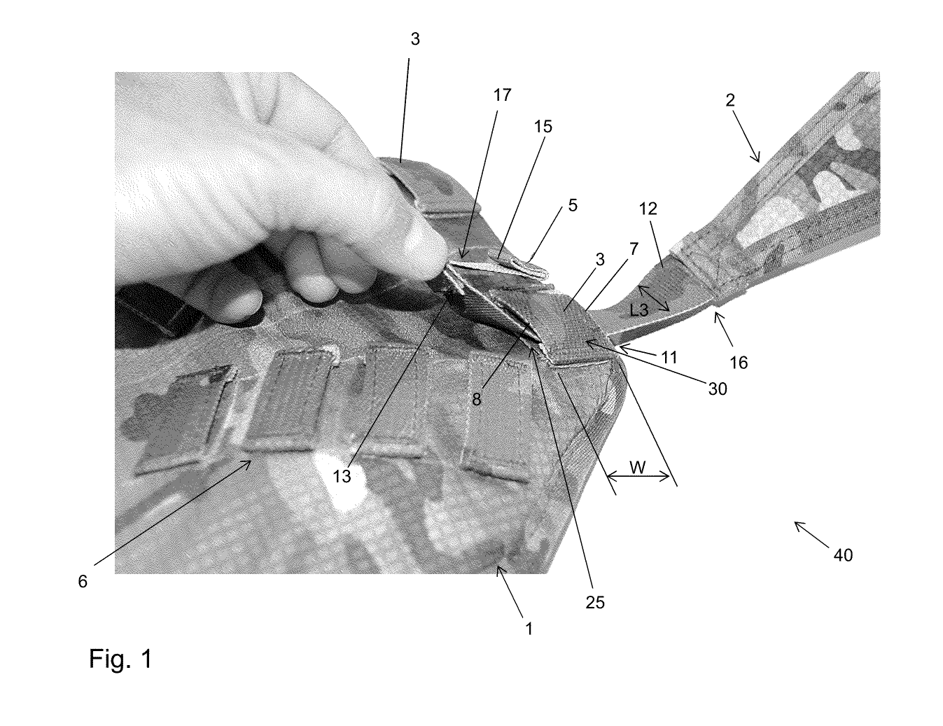

FIGS. 1 through 5 depict an embodiment of an auxiliary gear attachment system 40 and method in accordance with the present invention. As shown in FIG. 1, the present invention can be used with an article such as a vest or plate carrier 1 and similar wearable personal devices. Vests and plate carriers come in all shapes and sizes with a variety of optional accessories, and can include fixed attachment elements such as such as a series 6 of hook or loop fasteners for fastening various external peripheral items, for example. The attachment system of the present invention can comprise one or more fixed attachment webbing elements 3 secured to the article such as the personal wearable device 1 by various means, including, but not limited to, hook and loop, sewing, bonding, welding or otherwise connecting the elements 3 with the personal device 1.

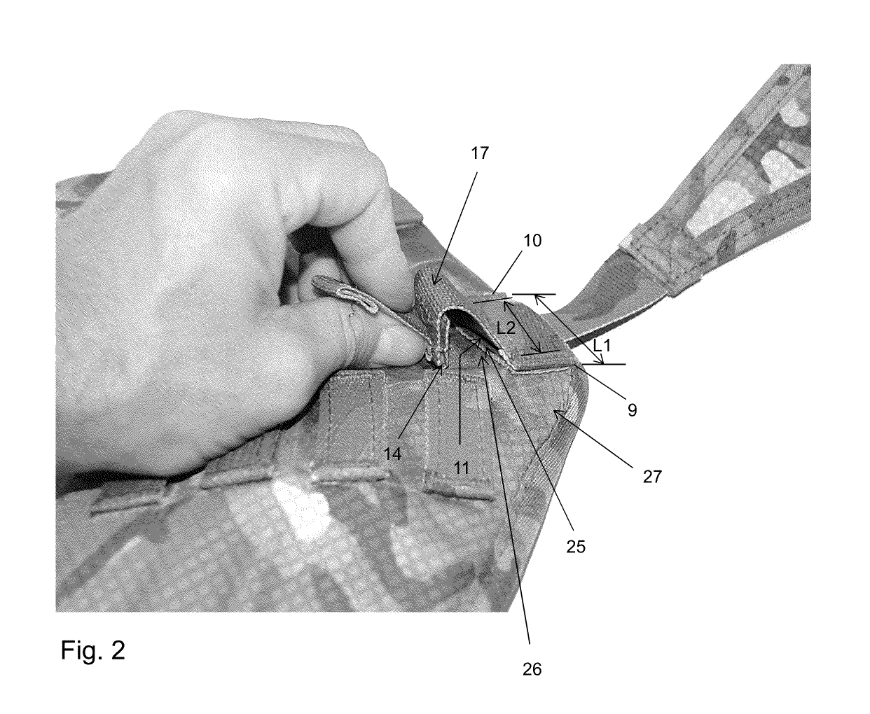

In one embodiment of the present invention, as shown in FIGS. 1 and 2, each fixed attachment webbing element 3 has a width W, as measured between a first edge 7 and a second edge 8 of the element 3. As shown in FIG. 2, each fixed attachment element 3 further has a length, L1, as measured between a top end 10 and a bottom end 9 of the attachment element 3. The bottom 9 and top 10 ends of the attachment element 3, may be secured to the wearable personal device 1 such that an opening 11 of length L2 exists between the bottom surface (not shown) of the outer retention strip 30 and the top surface of an intermediate retention strip 25 of the fixed attachment element 3. A second opening 26 of substantially the same length L2 exists between the outer surface 27 of the wearable personal device 1 and the bottom of the intermediate retention strip 25 of the fixed attachment element 3. As can be seen in FIG. 2, the length L1 is greater than the length L2. The outer 30 and intermediate 25 retention strips can be substantially flexible strips of material designed to permit stretching while also having integrated memory so as to return to a substantially flat shape when not being stretched. This design facilitates secure yet releasable retention of the elements of the strap 17 as described hereinafter.

As further shown in FIG. 1, the attachment system of the present invention can further comprise an article such as an auxiliary equipment item (also referred to as an auxiliary gear piece) 2 and a tongued attachment strap 17. The auxiliary gear piece 2 is attached to a first strap portion 12 of the strap 17 which is secured to the auxiliary gear piece at a first end 16 by means of attachment including, but not limited to, hook and loop, sewing, bonding or otherwise integrating the first strap portion 12 with the auxiliary gear device 2. In one embodiment of the present invention, the first strap portion 12 has a width L3 and includes a second end 13 opposite the first end 16. Width L3 is sufficiently narrow such that portion 12 can pass through opening 11.

As further shown in FIGS. 1 and 2, the first strap portion 12 can include a weighted attachment arrangement 4 at or near its second end 13, which can comprise a weight or stiffener that is integrated with the second end 13 by sewing or other attachment means, for example. At a top edge 14 of the weighted attachment arrangement 4 (also referred to as a connection point of a tongue), a second strap (also referred to as webbing or as a tongue) portion 15 of the tongued attachment strap 17 extends away from the weighted attachment arrangement 4 and back towards the first end 16 of the first strap portion 12. The tongue or second strap portion 15 is secured to the first strap portion 12 at the top edge 14 of the weighted attachment arrangement 4 by means of attachment including, but not limited to, hook and loop, sewing, bonding or otherwise integrating the first strap portion 12 with the second strap portion 15. The second end of portion 15 that is not attached to the first strap portion 12 can include a weighted anchor arrangement 5, which can comprise a weight or stiffener that is integrated with end 5 by sewing or other attachment means, for example.

It will be appreciated that the present invention can accommodate a single tongued attachment strap assembly. Alternatively, the present invention can comprise multiple tongued attachment strap assemblies that face the same or different directions.

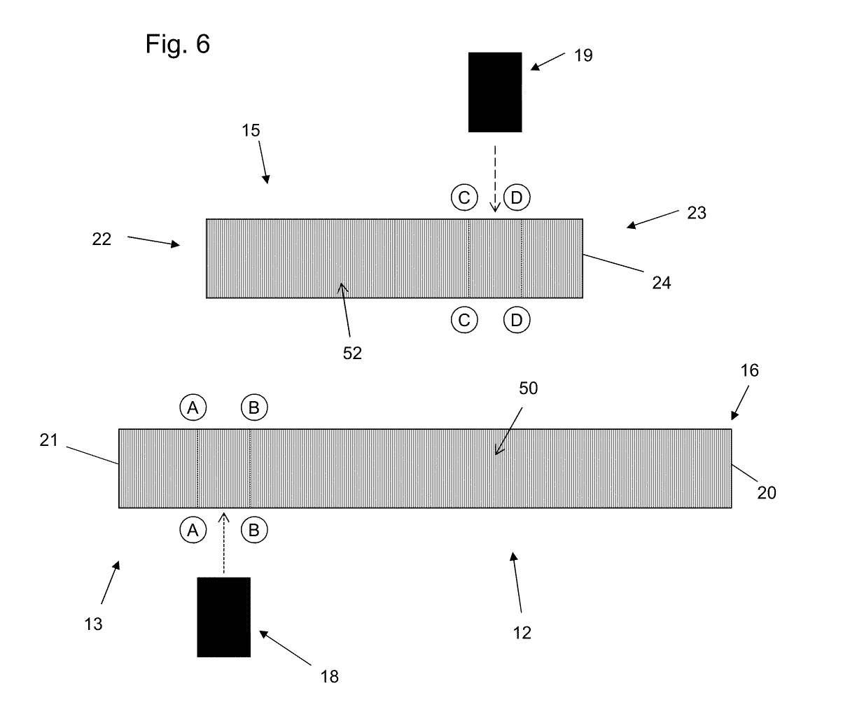

In one embodiment of the present invention, the tongued attachment strap 17 is manufactured by attaching various pieces of webbing and stiffeners to one another. As shown in FIG. 6, for example, one embodiment of the tongued attachment strap of the present invention comprises four individual components: a first strap portion 12, a second strap portion (also referred to as a tongue) 15, a first stiffener 18 and a second stiffener 19. The first 12 and second 15 strap portions have respective top surfaces (not shown) and bottom surfaces 50, 52. The first and second stiffeners, 18 and 19, respectively, can be substantially rectangular-shaped pieces made of metal or plastic, for example, which can vary in size (length, width and height), shape and weight to fit different embodiments of the present invention. As shown in FIG. 6, the first strap portion 12 includes a first end 16 and a second end 13. The first end 16 includes a first edge 20 and can be attached to an auxiliary gear piece 2 by means of attachment as described above. The second end 13 includes a second edge 21. The second strap portion 15 can include a first end 22 and a second end 23 with edge 24.

One method of manufacturing the tongued attachment strap 17 in accordance with the present invention includes placing a first stiffener 18 on top of the bottom surface of the first strap portion 12 in the area between the A-A and B-B lines shown in FIG. 6, as indicated by the dotted arrow. Before placing the first stiffener 18 on top of the bottom surface of the first strap portion 12, means for securing the stiffener to the strap portion, such as glue or other types of adhesive, may be applied to a first surface of the stiffener so that the stiffener will not move. Once the first stiffener 18 has been placed on the first strap portion 12, the first strap can be folded at the A-A line to cover the exposed surface of the stiffener such that the second edge 21 of the first strap portion 12 is substantially even with and parallel to the B-B line, and thus the second end can be secured to the first strap portion bottom surface 50. Again, means for securing the stiffener to the strap, such as glue or other types of adhesive, may be applied to a second surface of the stiffener prior to folding the strap over the stiffener. These first steps have now formed a weighted attachment end 4 of the first strap portion 12 of the tongued attachment strap 17. Further, the A-A line also represents a top edge 14 of the weighted attachment arrangement 4 as shown in FIGS. 1-3. It is also contemplated that the first strap and enclosed first stiffener can be folded a second time at the B-B line to increase the thickness of the weighted attachment end 4 in an alternative embodiment. In this case, the B-B line would represent the top edge 14 of the weighted attachment end 4. In addition or as an alternative to using an adhesive to secure stiffener 18, the stiffener can be sewn into strap portion 12, such as by sewing a seam connection portions of the first strap portion to each other and encompassing the stiffener 18, for example. The first strap portion 12 can then be flipped over such that the top surface of the strap portion 12 is face up.

Next, the first end 22 of the second strap portion 15 can be attached to the top surface of the first strap portion 12 at or substantially at the top edge 14 of the weighted attachment arrangement 4 by means of attachment including, but not limited to, hook and loop, sewing, bonding or otherwise integrating the first strap portion with the second strap portion. Depending on how the second strap portion is attached to the first strap portion, it may be preferable to attach the second strap portion to the first strap portion before forming the weighted attachment arrangement 4 as described above.

As illustrated in FIG. 6, a weighted anchor arrangement 5 can be formed at or near the second end 23 of the second strap portion 15. First, a second stiffener 19 is placed on top of the top surface of the second strap portion 15 in the area between the C-C and D-D lines as indicated by the dashed arrow, for example. Before placing the second stiffener 19 on top of the top surface of the second strap portion 15, means for securing the stiffener to the strap, such as glue or other types of adhesive, may be applied to a first surface of the stiffener so that the stiffener will not move. Once the second stiffener 19 has been placed on the second strap portion 15, the second strap portion can be folded at the D-D line to cover the exposed surface of the second stiffener such that the edge 24 of the second strap portion 15 is substantially even with and parallel to the C-C line, and the second end 23 can be secured to the bottom surface 52 of the second strap portion 15. Again, means for securing the stiffener to the strap, such as glue or other types of adhesive, may be applied to a second surface of the stiffener prior to folding the strap over the stiffener. If desired, the second strap portion can be folded a second time up and to the left (or towards the first end 22 of the second strap portion 15) at the C-C line. Means for securing the adjacent faces of the second strap portion 15 can be used, such as glue or another type of adhesive, so that the rolled strap and enclosed second stiffener do not come apart. In addition or as an alternative to using an adhesive to secure stiffener 19, the stiffener can be sewn into strap portion 15, such as by sewing a seam connection portions of the second strap portion to each other and encompassing the stiffener 19, for example. These steps form a weighted anchor arrangement 5 of the tongued attachment strap 17. In an alternative embodiment of the present invention, the second stiffener 19 is not used and the weighted anchor arrangement 5 comprises a tri-folded strap without additional weight in the form of a stiffener added. In this embodiment, the strap can be folded up and to the left (or towards the first end 22 of the second strap portion 15) first at the D-D line, next at the C-C line and then stitched together so that the folds remain intact. Other means of attachment such as glue or adhesive may be used to secure the tri-folded strap as well.

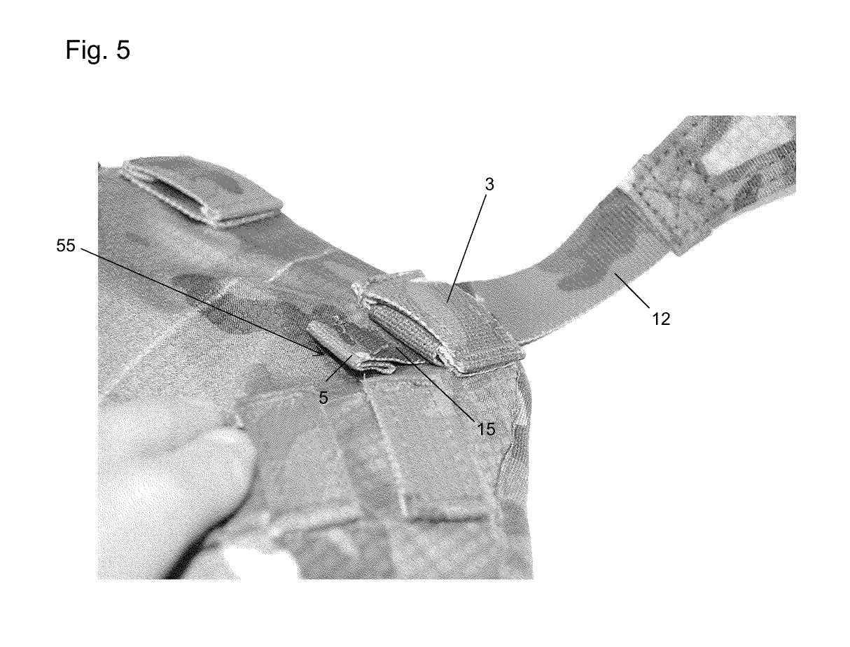

The present invention provides for snug connectivity with the personal device 1 through retention of a fixed attachment strap 3 and a weighted attachment arrangement 4 (FIG. 5). As shown in FIGS. 1-5, this retention can be accomplished, for example, by passing the tongued attachment strap 17 through the opening 11 in the fixed attachment element 3, flipping the weighted attachment arrangement 4 down and back 180 degrees and inserting the flipped weighted attachment arrangement 4 under the bottom of the intermediate member 25 and into opening 26 of the fixed member 3. As shown in FIG. 1, for example, a tongued end of a tongued attachment strap 17 is passed underneath outer surface 30 of element 3. The size of the opening 11 can vary to fit different embodiments of the tongued attachment strap 17. In one embodiment, the length L2 of the opening is substantially the same as the width L3 of the first 12 and second 15 strap portions of the tongued attachment strap 17. In an alternative embodiment, the length L2 of the opening is slightly greater than the width L3 of the first 12 and second 15 strap portions. The weighted attachment arrangement 4 of the first strap portion 12 can be used to pull the tongued attachment strap 17 far enough through the opening 11 such that the second strap portion 15 is also pulled through the opening 11.

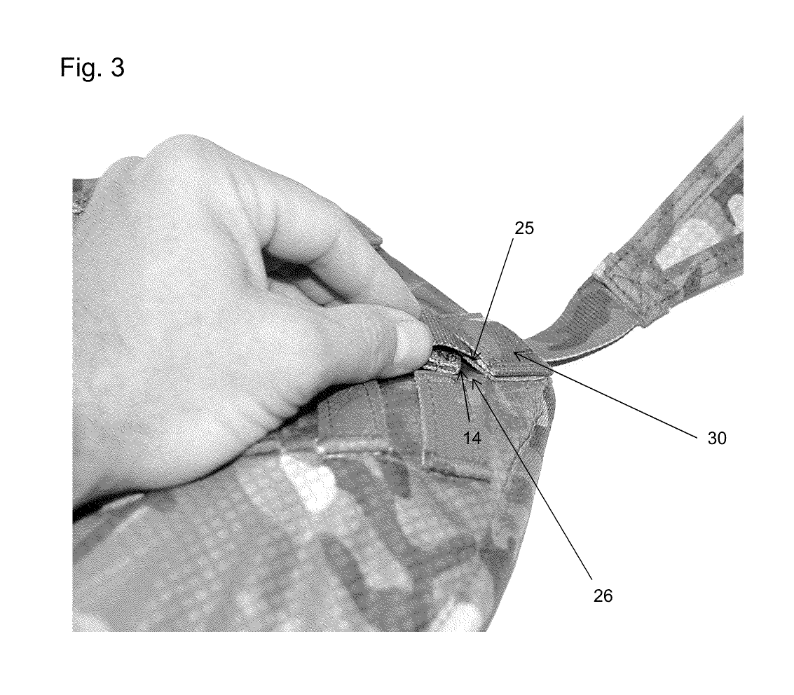

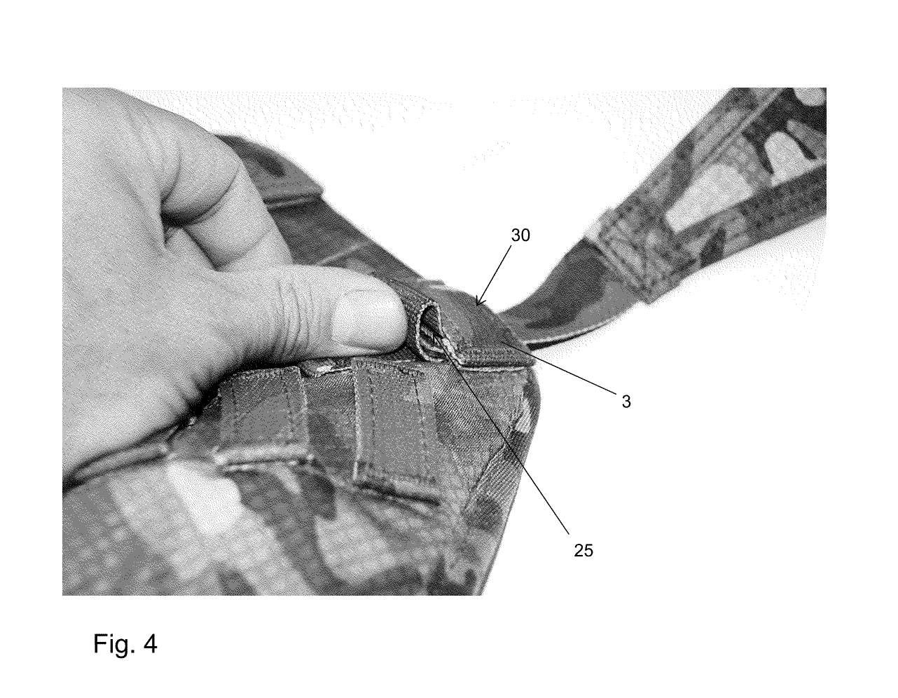

As shown in FIG. 2, the weighted attachment arrangement 4 of the first strap portion 12 is next folded down towards the surface of the wearable personal device 1, such that the second strap portion 15 and optional weighted anchor arrangement 5 of the tongue are flipped 180 degrees to now extend away from the fixed attachment element 3. As shown in FIG. 3, the weighted attachment arrangement 4 is next folded under the first strap portion 12 towards the fixed attachment element 3. As shown in FIG. 4, the weighted attachment arrangement 4 that is now folded down and under the first strap portion 12 can be inserted back into opening 26 and under the intermediate element 25 of the fixed attachment element 3. As shown in FIG. 5, once the folded weighted attachment arrangement 4 has been fully inserted under the intermediate element 25, the second strap portion 15 and weighted anchor arrangement 5 now extend outward and away from the second edge 8 of the fixed webbing element 3. The weighted anchor arrangement 5 can now serve as a pull-tab or release mechanism to detach the tongued attachment strap 17 from the fixed webbing element 3. The elements 25 and 30 of element 3 also assist in retaining strap 17 in position until the user desires to release it.

In one embodiment of the present invention, the attachment system strap portions comprise nylon webbing material, although suitable substitute materials can also be employed. In a further embodiment of the present invention, strap portion 15 can be provided with hook or loop connectors on the surface of the strap portion 15 that faces the surface of the device 1 when engaged, and the surface of the device 1 can be provided with loop or hook connectors (the opposite of what is provided on the strap portion 15) in order to facilitate secure yet releasable connection of the articles when engaged. In one embodiment of this aspect of the present invention, the surface of the device 1 below opening 26 contains the loop or hook connectors, and only a portion of the device-facing surface of the strap portion 15 that extends into opening 26 contains the hook or loop connectors. In another embodiment of the present invention, first strap portion 12 can contain hook or loop connectors that mate with surfaces of intermediate element 25 and/or element 3 to facilitate secure yet releasable connection of the articles when engaged. In yet another embodiment of the present invention, the second strap portion 15 is provided with hook or loop connectors near end 23 for mating with the surface of the device 1 outside of the area where element 3 resides, such as indicated at 55 in FIG. 5.

It should be understood that the foregoing description and examples are only illustrative of the present invention; the optimum dimensional relationships for the parts of the invention, including variations in size, materials, shape, form, function and the manner of operation, assembly and use, are deemed readily apparent to one skilled in the art, and all equivalent relationships to those illustrated in the drawings and described in the specification are intended to be encompassed by the present invention. Thus, various alternatives and modifications can be devised by those skilled in the art without departing from the invention. Accordingly, the present invention is intended to embrace all such alternatives, modifications, and variances that fall within the scope of the appended claims.

1. An auxiliary gear attachment system, comprising:
a tongued attachment strap securable to a first article, the strap having a first strap portion and a second strap portion, with the first strap portion comprising:
a strip of resilient, flexible material having a top surface and a bottom surface, a first end securable to the first article and a second end having an edge that is folded over such that the second end is secured to the bottom surface thereby;
and with the second strap portion comprising:
a strip of resilient, flexible material having a first end securable to the second end of the material strip of the first strap.

2. The system of claim 1 wherein the second strap portion material strip has a top surface, a bottom surface and a second end, with the second end having an edge that is folded over such that the second end is secured to the second strap portion bottom surface.

3. The system of claim 1 further including a first stiffener secured to the bottom surface of the first strap portion material strip and wherein the second end of the first strap portion material strip is folded over the first stiffener.

4. The system of claim 2 further including a second stiffener secured to the bottom surface of the second strap portion material strip and wherein the second end of the second strap portion material strip is folded over the second stiffener.

5. The system of claim 1, further comprising:
an inner retention strip having a top surface and a bottom surface, a top end and a bottom end, each of the inner strip ends being securable to a second article such that the inner strip bottom surface forms a first opening when secured to the second article; and
an outer retention strip having a top surface and a bottom surface, a top end and a bottom end, each of the outer strip ends being securable to the second article such that the outer strip bottom surface and the inner strip top surface form a second opening.

6. The system of claim 5, wherein the inner retention strip and outer retention strip are comprised of flexible material.

7. The system of claim 5 wherein the second strap portion is entirely insertable through the second opening and wherein the first strap portion second end is insertable through the second opening and the first opening.

8. The system of claim 5 wherein the first strap portion second end is engageable with the bottom surface of the inner retention strip and the second article so as to releasably maintain the tongued attachment strap within the first opening.

9. The system of claim 8 wherein the second strap portion includes hook or loop type connectors so as to releasably maintain the tongued attachment strap to the second article.

10. A method for releasably securing a first article to a second article, comprising:
securing a tongued attachment strap to a first article, the strap having a first strap portion and a second strap portion, with the first strap portion comprising:
a strip of resilient, flexible material having a top surface and a bottom surface, a first end securable to the first article and a second end having an edge that is folded over such that the second end is secured to the bottom surface thereby;
and with the second strap portion comprising:
a strip of resilient, flexible material having a first end securable to the second end of the material strip of the first strap; and
releasably securing the strap to a second article.

11. The method of claim 10 wherein the second strap portion material strip has a top surface, a bottom surface and a second end, with the second end having an edge, and including the step of folding over the second end edge such that the second end is secured to the second strap portion bottom surface.

12. The method of claim 10 further including the step of securing a first stiffener to the bottom surface of the first strap portion material strip and folding the second end of the first strap portion material strip over the first stiffener.

13. The method of claim 11 further including the step of securing a second stiffener to the bottom surface of the second strap portion material strip and folding the second end of the second strap portion material strip over the second stiffener.

14. The method of claim 10, further comprising:
providing an inner retention strip having a top surface and a bottom surface, a top end and a bottom end, and securing each of the inner strip ends to the second article such that the inner strip bottom surface forms a first opening when secured to the second article; and
providing an outer retention strip having a top surface and a bottom surface, a top end and a bottom end, and securing each of the outer strip ends to the second article such that the outer strip bottom surface and the inner strip top surface form a second opening.

15. The method of claim 14, wherein the inner retention strip and outer retention strip are comprised of flexible material.

16. The method of claim 14 further comprising the step of inserting the second strap portion entirely through the second opening and inserting the first strap portion second end through the second opening and the first opening.

17. The method of claim 10 wherein the first strap portion second end is engageable with the bottom surface of the inner retention strip and the second article so as to releasably maintain the tongued attachment strap within the first opening.

18. The method of claim 17 wherein the second strap portion includes hook or loop type connectors so as to releasably maintain the tongued attachment strap to the second article.
